(19) United States
(12) Patent Application Publication
(10) Pub. No.: US 2011/0167626 A1
(43) Pub. Date: Jul. 14, 2011

(54) STRUCTURE FOR INSTALLING SPLIT-STYLE DIAMOND GRINDING DISK

(76) Inventor: Hongyu YE, Wuhan (CN)

(21) Appl. No.: 12/791,981

(22) Filed: Jun. 2, 2010

(30) Foreign Application Priority Data
Jan. 12, 2010 (CN) 201010028965.3

(51) Int. Cl. B23P 19/00

(52) U.S. Cl. 29/700

(57) ABSTRACT

A structure for installing a split style diamond disk, having a fixing plate, a spring press plate, a connection plate, and a plurality of fast installation grinding blocks. The spring press plate is fixed to the fixing plate through screws with springs sleeved thereon, and the connection plate runs through the spring press plate and connects with the fixing plate by screws. The fixing plate has a plurality of L-shaped grooves provided therein, through which the fast installation grinding blocks are mounted on the fixing plate. The fast installation structure is mounted on an equipment shaft through the connection plate. The structure improves the capacity utilization and work efficiency of the grinding blocks.

### CROSS-REFERENCE TO RELATED APPLICATIONS

Pursuant to 35 U.S.C.§119 and the Paris Convention Treaty, this application claims the benefit of Chinese Patent Application No. 20100028965.3 filed Jan. 12, 2010, the contents of which are incorporated herein by reference.

### BACKGROUND OF THE INVENTION

1. Field of the Invention

The invention relates to a diamond disk used for plane grinding of nonmetal materials, and more particularly to a structure for installing a split-style diamond grind disk which can be quickly installed and disassembled and has a low cost.

2. Description of the Related Art

Conventional diamond disks are generally an integrated product which consists of a steel base and a diamond segment. An integral disk is usually manufactured by a conventional method in which the diamond segment is welded to the steel base, and the grinding operation of the disk is accomplished by the diamond segment. After the diamond segment is consumed, the integral diamond disk is out of run, resulting in low capacity utilization and high cost. Conventional integral diamond disks are fixed to an equipment shaft via screws and have disadvantages of slow installation and disassembly speed and inconvenient use, which directly affect the work efficiency of the disk.

### SUMMARY OF THE INVENTION

Accordingly, in view of the above-described problems, it is one objective of the invention to provide a structure for installing a split-style diamond grind disk which can be quickly installed and disassembled and has low cost, and thereby the capacity utilization and work efficiency of the disk are improved.

To achieve the above-mentioned objective, in accordance with one embodiment of the invention, there is provided a structure for installing a split-style diamond grind disk comprising a fixing plate, a spring press plate, a connection plate, and a plurality of fast installation grinding blocks; the spring press plate is fixed to the fixing plate through screws with springs sleeved thereon; the connection plate runs through the spring press plate and connects with the fixing plate by screws; the fixing plate has a plurality of L-shaped grooves provided therein, through which the fast installation grinding blocks are disposed on the fixing plate; and the whole fast installation structure is mounted on an equipment shaft through the connection plate.

The fast installation grinding blocks are disposed by aligning the fast installation grinding blocks with the corresponding L-shaped grooves in the fixing plate and pressing them into the L-shaped grooves so as to make the spring press plate to compress the springs sleeved on the screws to form a gap, so that the fast installation grinding blocks run through the L-shaped grooves in the fixing plate and push the fast installation grinding blocks outwardly to their work positions. The spring press plate presses against the fast installation grinding blocks to fix them after returning to the original position thereof.

In a class of this embodiment, there are four screws with springs sleeved thereon which connect the spring press plate with the fixing plate and four screws connecting the connection plate with the fixing plate, and they are distributed evenly.

In a class of this embodiment, the screws with springs sleeved thereon which connect the spring press plate with the fixing plate and the screws connecting the connection plate with the fixing plate are countersunk head screws.

Advantages of the present invention are summarized below. According to the characteristics of diamond disks, the invention uses the spring press plate and special L-shaped grooves to achieve a quick installation and disassembly of the grinding blocks. If the diamond segment is abrased, the grinding blocks can be replaced while the disk can be used repeatedly so that the work efficiency and capacity utilization of the disk is improved and, in turn, the consumption of steel and the cost is reduced.

### BRIEF DESCRIPTION OF THE DRAWINGS

The invention is described hereinbelow with reference to accompanying drawings, in which:

FIG. 1 is a schematic diagram of a fast installation structure of a split style diamond disk according to one embodiment of the invention;

FIG. 2 is a top view of a fast installation structure of a split style diamond disk as shown in FIG. 1;

FIG. 3 is a schematic diagram of a fixing plate according to one embodiment of the invention;

FIG. 4 is a schematic diagram of a spring press plate according to one embodiment of the invention;

FIG. 5 is a schematic diagram of a connection plate according to one embodiment of the invention;

FIG. 6 is a schematic diagram of a fast installation grinding block according to one embodiment of the invention;

FIG. 7 is a top view of a fast installation grinding block as shown in FIG. 6; and

FIG. 8 is a side view of a fast installation grinding block as shown in FIG. 6.

### DETAILED DESCRIPTION OF THE EMBODIMENTS

For further illustrating the invention, experiments detailing a fast installation structure of a split style diamond disk are described below. It should be noted that the following examples are intended to describe and not to limit the invention.

The drawings disclose an embodiment of the present invention. In the drawings, the relations between reference numbers and the components are as follow: 1. a fixing plate of a fast installation grinding block; 2. a spring press plate of the fast installation grinding block; 3. a connection plate; 4. a fast installation grinding block; 5. a screwdriver; 6. a spring; 7. a screw with a spring sleeved thereon; 8. L-shaped grooves in the fixing plate; and 9. a screw through the connection plate and the fixing plate.

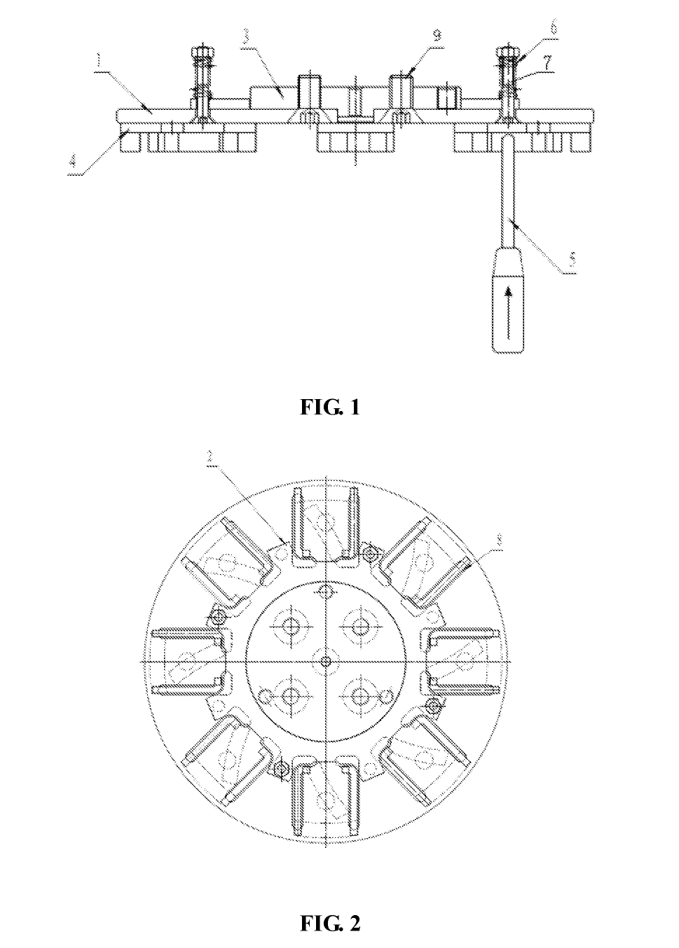

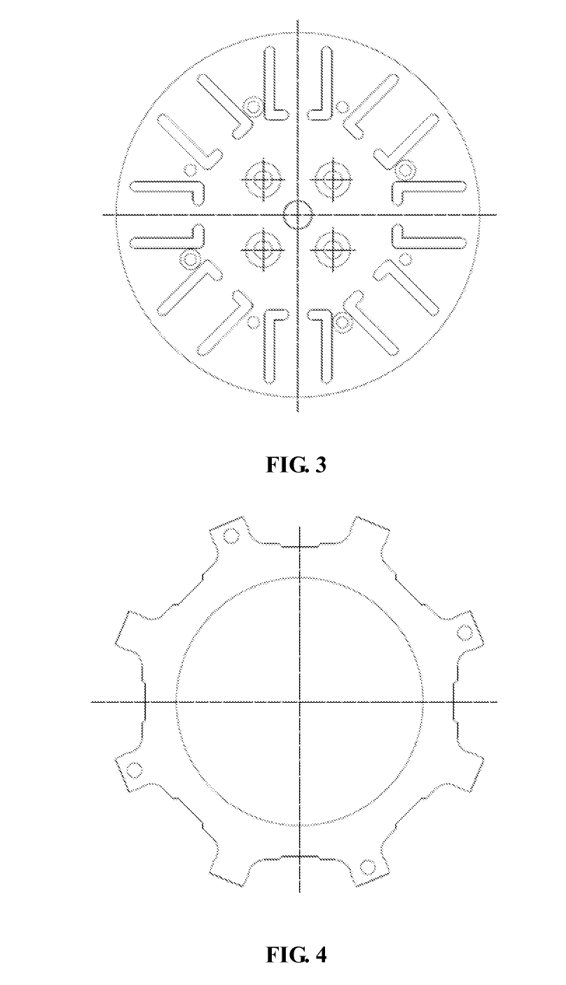

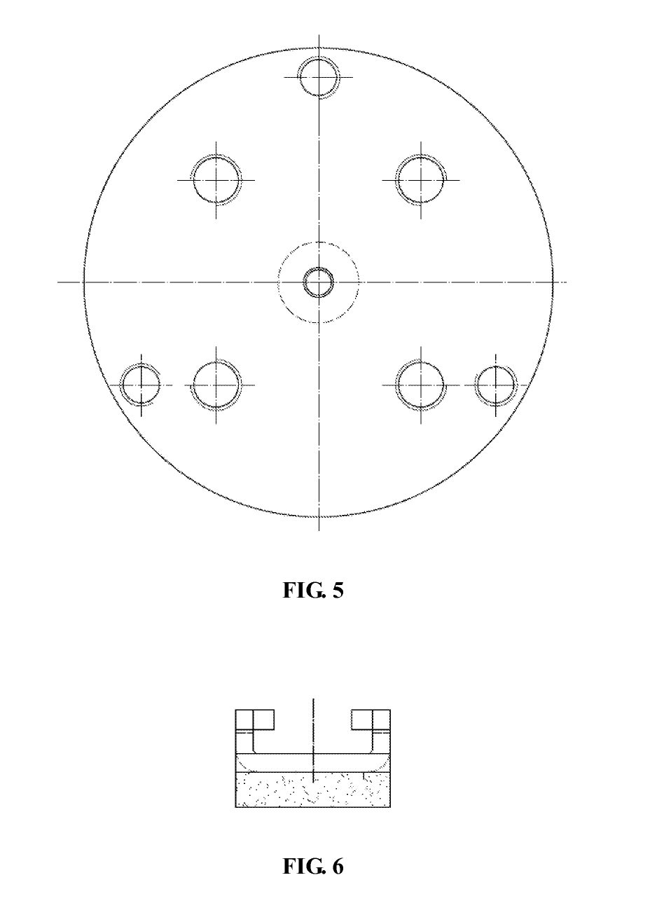

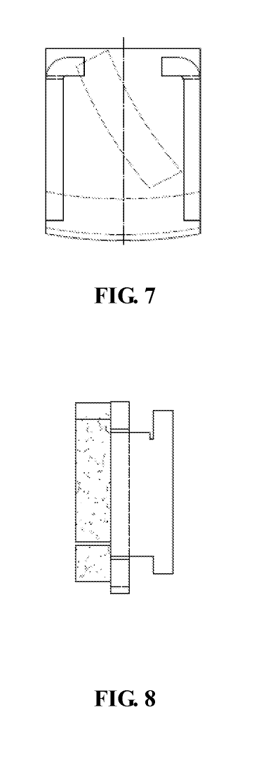

As shown in FIGS. 1 and 2, a spring press plate 2 is mounted on a fixing plate 1 through four screws 7 with springs 6 sleeved thereon. A connection plate 3 runs through the spring press plate 2 and connects with the fixing plate 1 through four countersunk head screws 9 so as to form a fast installation structure fixed to an equipment shaft. In this structure, the combination of the fixing plate 1, the spring press plate 2 and the connection plate 3 is equivalent to the steel base of a conventional integral disk, and the fast installation grinding block 4 is equivalent to the diamond segment of the conventional integral disk.

The fixing plate 1 has special L-shaped 8 grooves formed therein, through which the fast installation grinding block 4 is fixed to the fixing plate 1. When assembling, the fast installation grinding block 4 is aligned with and pressed into the special L-shaped groove 8 in the fixing plate 1 so that the spring press plate 2 compresses the spring 6 sleeved on the screw 7 to form a gap and, in turn, the fast installation grinding block 4 runs through the L-shaped groove 8 in the fixing plate 1 and then the fast installation grinding block 4 is pushed outwardly to a work position. The spring press plate 2 will press against the fast installation grinding block 4 after its self-reset. When disassembling the fast installation grinding block, push the spring press plate 2 upwardly to form a gap with a screwdriver 5 and push the fast installation grinding block toward center of a circle so that the fast installation grinding block 4 can be dismounted. Thus, the fast installation structure of a split style diamond disk of the present invention is convenient for installation, disassembly, and usage.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A structure for installing a split-style diamond grinding disk, comprising:
a fixing plate (1),
a spring press plate (2),
a connection plate (3), and
a plurality of fast installation grinding blocks (4), wherein
said spring press plate (2) is fixed to said fixing plate (1) through screws (7) with springs (6) sleeved thereon;
said connection plate (3) runs through said spring press plate (2) and connects with said fixing plate (1) by screws (9);
said fixing plate (1) has a plurality of L-shaped grooves (8) provided therein, through which said fast installation grinding blocks (4) are disposed on said fixing plate (1); and
the installation structure is mounted on an equipment shaft through said connection plate (3).

2. The structure of claim 1, wherein said fast installation grinding blocks (4) are disposed by aligning said fast installation grinding blocks (4) with the corresponding L-shaped grooves (8) in said fixing plate (1) and pressing them into the L-shaped grooves (8) whereby making said spring press plate (2) to compress said springs (6) sleeved on said screws (7) to form a gap, whereby said fast installation grinding blocks (4) run through said L-shaped grooves (8) in said fixing plate (1) and push said fast installation grinding blocks (4) outwardly to their work positions, said spring press plate (2) pressing against said fast installation grinding blocks (4) to fix them after returning to the original position thereof.

3. The structure of claim 1, wherein there are four screws (7) with springs sleeved thereon which connect said spring press plate (2) with said fixing plate (1) and four screws (9) connecting said connection plate (3) with said fixing plate (1), and they are distributed evenly.

4. The structure of claim 1, wherein said screws (7) with springs sleeved thereon which connect said spring press plate (2) with said fixing plate (1) and said screws (9) connecting said connection plate (3) with said fixing plate (1) are countersunk head screws.

5. The structure of claim 3, wherein said screws (7) with springs sleeved thereon which connect said spring press plate (2) with said fixing plate (1) and said screws (9) connecting said connection plate (3) with said fixing plate (1) are countersunk head screws.
